(19) United States
(12) Patent Application Publication
(10) Pub. No.: US 2006/0180007 A1
(43) Pub. Date: Aug. 17, 2006

(54) Music and audio composition system

(76) Inventor: Jason McClinsey, Middletown, NY (US)

Correspondence Address: PETER J. GORDON, PATENT COUNSEL, AVID TECHNOLOGY, INC., ONE PARK WEST, TEWKSBURY, MA, 01876, US

(21) Appl. No.: 11/325,707

(22) Filed: Jan. 5, 2006

Related U.S. Application Data
(60) Provisional application No. 60/641,474, filed on Jan. 5, 2005.

(51) Int. Cl. G10H 7/00

(52) U.S. Cl. 84/645

(57) ABSTRACT

A music or audio composition system, or other composition system for time-based media such as video, defines a composition using a set of tracks. Similar to a traditional track, each track in the composition system is represented in a graphical user interface as a timeline. However, each track also has its own attributes that are used to access a content database. As a result, each track may have its own context-sensitive browser or other mechanism to access the content database. The attributes of a track may include, for example, an associated instrument category, musical style and qualifying parameters. In the graphical user interface, if a user selects a track and inputs search parameters for browsing the database, the results from the database are limited to those that also match the attributes of the track in addition to the user-provided search parameters. For example, the browser for a drum track will provide drum clips; the browser for a bass track will provide bass clips. Clips in the browser for a track also may be auditioned. These clips are auditioned by playing them on the track (thus using the level, pan and effect presets of the track) with which the browser is associated. Such auditioning of the content using the various settings of the track makes the auditioning context-sensitive. Effects and synthesizer sounds also may be auditioned. Multiple clips can be selected for auditioning on different tracks. By creating a composition that includes multiple tracks for content to be auditioned, selected clips for multiple different tracks may be played back for simultaneous auditioning. A selected clip may be dragged and dropped on the timeline portion associated with that track to add the clip to the composition.

### CROSS REFERENCE TO RELATED APPLICATIONS

This application is a nonprovisional application that claims priority under 35 U.S.C. 119 to previously filed provisional application Ser. No. 60/641,474, filed Jan. 5, 2005, which is hereby incorporated by reference.

### BACKGROUND

Computer programs are available that support creation of musical and other audio compositions. Such programs are commonly called sequencers. A sequencer generally has a graphical user interface that permits a user to place audio and/or MIDI data on one or more tracks. Each track typically is represented by a timeline, and may display a waveform of the audio data, and/or MIDI notes. A section of audio or MIDI data on a track is commonly called a clip. In general, a user may edit the position and duration of a clip on the track, indicate whether the clip is to be played in a loop, and perform pitch shifting and time stretching operations on the clip. The user also may search for audio files available to the computer to locate and add clips to a composition.

### SUMMARY

A music or audio composition system, or other composition system for time-based media such as video, defines a composition using a set of tracks. Similar to a traditional track, each track in the composition system is represented in a graphical user interface as a timeline. However, each track also has its own attributes that are used to access a content database. As a result, each track may have its own context-sensitive browser or other mechanism to access the content database. The attributes of a track may include, for example, an associated instrument category, musical style and qualifying parameters. In the graphical user interface, if a user selects a track and inputs search parameters for browsing the database, the results from the database are limited to those that also match the attributes of the track in addition to the user-provided search parameters. For example, the browser for a drum track will provide drum clips; the browser for a bass track will provide bass clips.

Clips in the browser for a track also may be auditioned. These clips are auditioned by playing them on the track (thus using the level, pan and effect presets of the track) with which the browser is associated. Such auditioning of the content using the various settings of the track makes the auditioning context-sensitive. Effects and synthesizer sounds also may be auditioned. Multiple clips can be selected for auditioning on different tracks. By creating a composition that includes multiple tracks for content to be auditioned, selected clips for multiple different tracks may be played back for simultaneous auditioning. A selected clip may be dragged and dropped on the timeline portion associated with that track to add the clip to the composition.

For audio, a track may handle audio clips or MIDI clips, but both kinds of clips are handled in the same manner. Clips may be normal or looped. Sound clips, synthesizers and settings for audio processing operations may be stored in files on a file system on a computer and indexed in a database. The database indexes the stored files and permits a user to categorize the files using metadata such as instrument type, musical style and qualifying parameters. In addition to the context-sensitive browse and audition capability provided for each track, a global browse and audition capability on the database can be provided.

In the graphical user interface, each track also has its own control to separately control volume and panning. The volume control also acts as an audio meter during playback.

### BRIEF DESCRIPTION OF THE DRAWINGS

In the drawings,

FIG. 1 is a dataflow diagram illustrating an example implementation of a music and audio composition system.

FIG. 2 is a diagram of an example graphical user interface for a music and audio composition system.

FIG. 3 is an enlarged diagram of a portion of a control panel of FIG. 2.

FIG. 4 is an enlarged diagram of a toolbar of FIG. 2.

FIG. 5 is an enlarged diagram of part of a track from FIG. 2.

### DETAILED DESCRIPTION

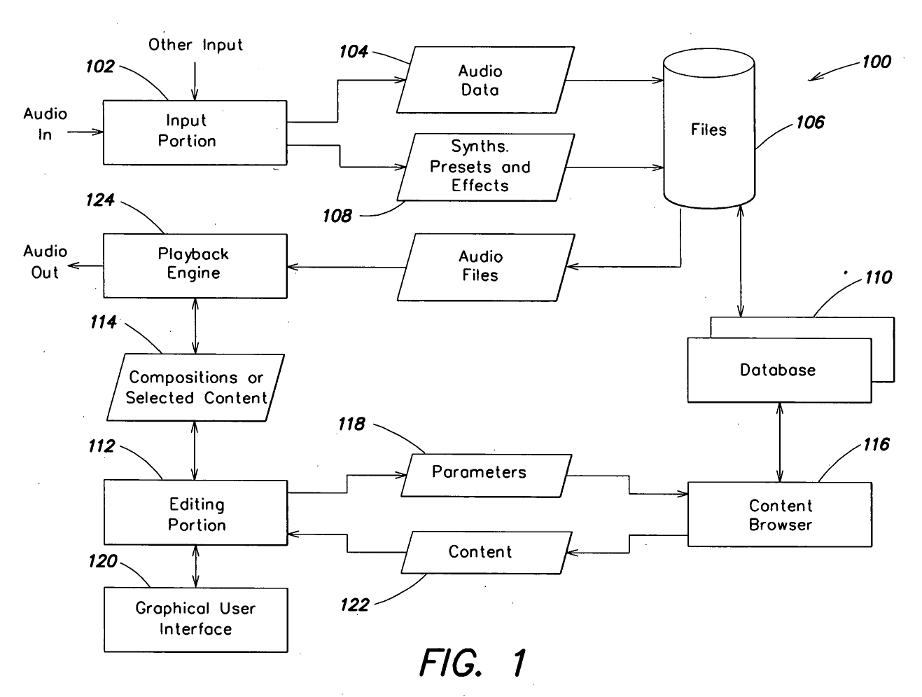

Referring now to FIG. 1, a dataflow diagram illustrating an example implementation of a music and audio composition system will now be described. It should be understood that this example of a music and audio composition system is not limiting and that the invention can also be applied to other composition systems for time-based media such as video.

The composition system 100 includes an input portion 102 for capturing input audio, such as from a microphone or other source, into audio data files 104 stored in the file system 106 of a computer. The input portion 102 also permits MIDI data, presets for mixing operations, effects and synthesizers to be defined by, or imported into, data files 108 stored in the file system 106. These data files may be stored in directories in the file system which are dedicated to the composition system.

A clip database 110 adds metadata to the data stored in the file system. The metadata may include, but is not limited to, categories. Categories may include an instrument type, musical style and/or qualifying parameters. The user may add or delete categories, and categorize the data. If the metadata is stored in the data files, a rescan function can be provided. A rescan function searches all data in designated directories in the file system and extracts the metadata to update the database. The database can be updated each time the composition system is started, or upon instruction from a user.

The editing portion 112 is used to create compositions 114. The editing portion relies on several data structures that represent the composition being created. The base data structure is called a composition. A composition includes a list of tracks. For an audio composition, each track may have a number of defining parameters, such as a name, tempo, pitch, estimate of RAM use, size (in Mb) and total size of audio used. Each track is represented by a data structure that includes a list of audio clips, mixing and effect operations on the timeline for the track. Each track also has associated metadata or attributes, corresponding to metadata used by the database, such as an instrument type, style type and qualifying parameters. For an audio composition, a track may be, for example, an audio track or a MIDI track. Each clip is represented by a data structure that includes a reference to a file, and has a type (normal or looped). There are several parameters for looped clips that also conventionally are stored. Events represented on the timeline for a track are played back in synchronism with events on the timelines for the other tracks in the composition.

To permit a user to efficiently edit a composition, a graphical user interface 120 is provided. The graphical user interface permits a user to select graphical elements on a display using a pointing device, or to enter data though text boxes on the display, that provide access to and parameters for the various functions provided by the editing portion 112. An example graphical user interface is described in more detail below.

To create a composition, tracks are added to the composition, and clips, such as sounds and effects, are added to tracks. The user can indicate a desire to add a track or, through the graphical user interface, place a clip in the composition, which will add a track to the composition using default values taken from the clip. When a track is added, the user may select its associated metadata, such as values for an instrument type, musical style and qualifying parameters. The metadata options may be obtained from the database and presented to the user. Other properties of the track also may be set.

A set of named presets for the properties of each track also may be provided. Presets that are particularly useful are those that correspond to typical activities of a user, such as play and record a guitar on a track, create music with audio loops, record stereo line in, play and record with a keyboard, and create music with MIDI loops. Selection of some of these options could result in further prompts to the user to permit a user to select attributes (instrument type and musical style) for a track to be created, or other parameters (such as the sound to be played from a keyboard).

To permit a user to select audio and effects to be placed in the composition, the editing portion 112 permits a user to browse and search the database 110. In particular, a content browser 116 receives, from the editing portion, parameters 118 limiting browsing or searching. It accesses the database and returns indicia of content 122 that meets the specified parameters 118. The content browser may be context-insensitive as is conventional, or may be context-sensitive for each track in the composition by limiting results to those that match the metadata established for the track. The browser also may permit a user to select and audition content in the track. Through the graphical user interface 120, the editing portion 112 displays indicia of the identified content to permit the user to select content for auditioning, or for use in the composition that is being edited, or for other operations (such as modifying its associated metadata).

A user also may request playback of a composition (or other content selected by the user such as for auditioning) which is performed through a playback engine 124. The composition, or other content, is processed to provide appropriate data instructions according to the audio (or other media) playback capabilities of the computer being used. For example, the computer may use the Microsoft WDM kernel-streaming architecture for audio playback. Playback provides audio and video output to any of a number of output devices, such as speakers and video monitors. Such output also may be recorded.

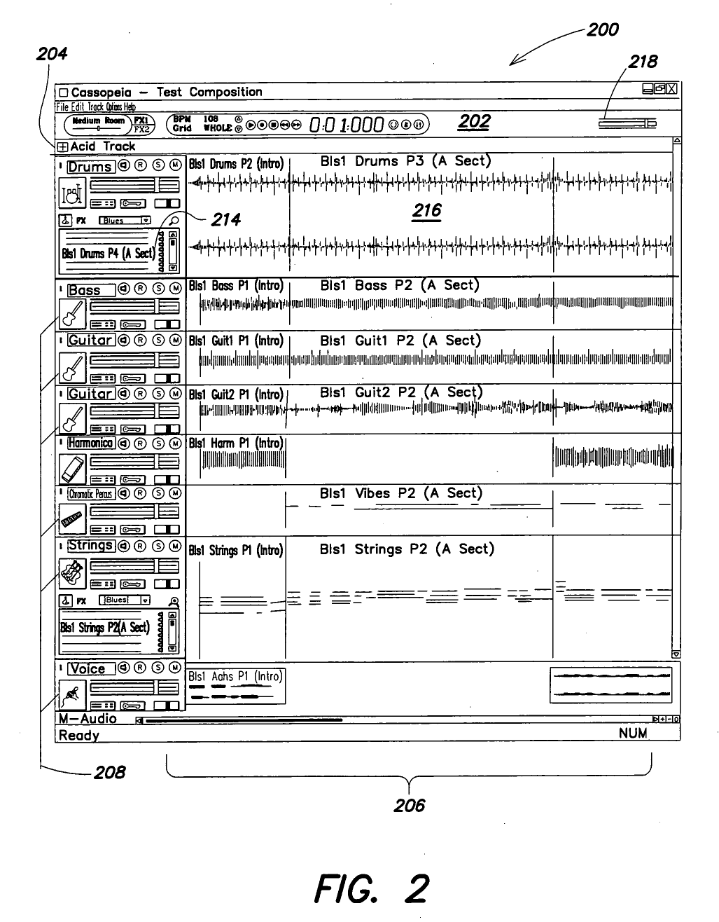

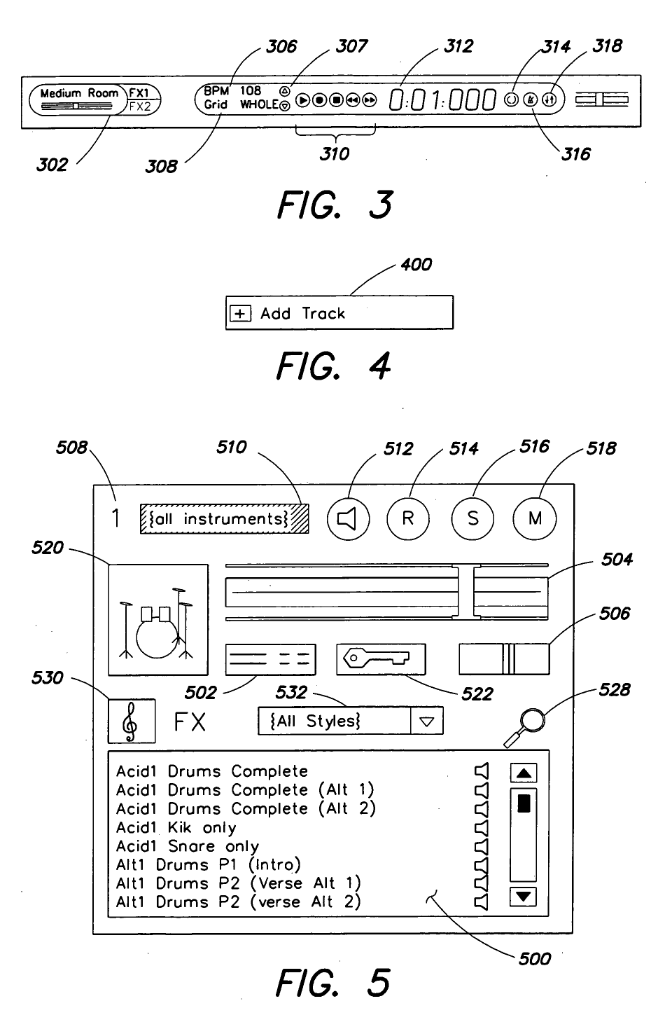

An example graphical user interface 200 for such a system will now be described in connection with FIGS. 2-3. In this example, the graphical user interface 200 includes a control panel 202, a toolbar 204, a timeline 206, and tracks 208. Each of these elements will now be described in more detail. A graphical user interface also can include a master track button (not shown) and a global content browser (not shown), which are described in more detail below.

The control panel 202 will be described in more detail in connection with FIGS. 2 and 3. In FIG. 2, the control panel includes a master volume control slider 218, which allows for level control for the stereo output of playback from the composition system.

Other elements of the control panel are shown in FIG. 3. A global effects control 302 provides access to two global effects that are applied to a composition. A user may select either “FX1” or “FX2” and then select a “Reverb Type” through a drop-down menu. Defaults for these effects may be a short reverb and a long reverb. The display of the timeline 206, as described below, is updated to set a current playback position, called the transport, to a position marker. A marker selection control (not shown) may be provided, for example in the form of a drop down menu that allows the user to select a position marker in the composition.

The beats per minute for playback of the composition is represented by the tempo 306. A user may select the tempo and enter a new tempo through the keyboard, or may adjust the tempo using the pointing device. For example, in response to a user clicking on a tempo control button 307, a pop-up slider is displayed, which in turn permits the user to drag a control to the left to decrease the tempo, or drag to the right to increase the tempo. A variety of other ways can be used to adjust tempo, for example, in response to the user clicking and holding the left button on a mouse, the value may be decreased; in response to the user clicking and holding the right button on the mouse, the value may be increased.

A snap grip control 308 provides a drop down menu to adjust the “snap grid”. The snap grid indicates the resolution in time to which editing operations are automatically made, for example when dragging or dropping a clip on a timeline. Playback and record control buttons also are provided at 310. Example controls include play, record, stop and rewind to the beginning, rewind and fast-forward. The stop and rewind to the beginning control stops playback if it is pressed during playback, and rewinds to the beginning if it is pressed when playback is already stopped.

Also in FIG. 3, a position display and control 312 displays the current position in time of the composition. This value is updated, for example, continually during playback. The user may select this value with a pointing device and enter a position in time. Time may be displayed in hours, minutes and seconds or in musical time. A cycle on/off button 314 allows a user to activate looping within the composition according to a set of markers displayed, when looping is activated, on the timeline. The set of markers (not shown) may be manipulated on the timeline to permit the user to specify in time where a cycle begins and ends. Similarly, a punch-in/punch-out button 318 allows a user to activate punch-in recording within the composition. A set of markers is displayed on the timeline when punch-in recording is activated. The set of markers (not shown) may be manipulated on the timeline to specify where in the composition the recorded audio will be punched-in. A metronome button 316 represents controls for a metronome. Using a pointing device, when selected, the metronome button is turned on or off. A drop down menu with settings for the metronome also may be displayed. A button (not shown) may be provided for hiding or showing a global content browser.

The toolbar 204 will be described in more detail in connection with FIG. 4. The toolbar includes an Add Track button 400 which, when selected, permits a user to add a new track to the composition. A dialog box or other similar display may be provided to permit a user to enter information about the new track, such as its instrument type, musical style and qualifying parameters. A menu can be generated from known available values for these parameters as used in the database. Effect settings, mixing presets or synthesizer values (for MIDI patches) also may be input or selected from a menu. The dialog box may display different options for audio and MIDI tracks, which may be presented in a mutually exclusive manner via a selection mechanism, such as a tab or radio button selector.

The toolbar also may be modified to include other tools, such as a select tool, a scissor tool, a pencil tool and/or an eraser tool. A select tool establishes a normal mode of operation of the user interface using a pointing device, which permits a user to select, drag and drop objects in the user interface. A scissor tool sets the pointing device in a mode in which the user may split a clip on the timeline into multiple clips. A pencil tool sets the pointing device in a mode in which a user may draw MIDI clips or edit notes in a piano roll editor. An eraser tool allows the user to delete clips and erase notes in a piano roll editor.

Referring again to FIG. 2, the timeline 206 is a graphic representation of time, displayed in measures and beats. It includes a numeric display indicating measures at the top of the timeline area and a scroll bar at the bottom of the timeline area. In the timeline a current position indicator may be shown as a long vertical line. Other kinds of markers that may be similarly displayed also may be used in the timeline. Examples of such markers include, but are not limited to, for indicating cycle start and end times, punch-in and punch-out times or a position marker.

Conventional editing operations are performed using the pointing device and keyboard as inputs. Such editing operations include selecting clips, trimming clips, splitting clips, moving clips, deleting clips, cutting clips, copying clips, pasting clips, drag and drop copy and paste of clips, and combining clips.

Tracks 208 are displayed in a vertically stacked arrangement beneath the control panel. Each track includes a control portion 214 (described in more detail in connection with FIG. 5) and a timeline portion 216. The timeline portion displays waveforms or MIDI information depending on the type of the track in the context of the timeline 206. A MIDI track also may display a “piano roll” (not shown) at the edge of the timeline portion to permit piano roll editing. If the content browser (500 in FIG. 5) is hidden in the control portion, the entire tracks display may be reduced in height in the display.

Referring to FIG. 5, the control portion will now be described in more detail. The control portion may display a context-sensitive content browser 500 (described in more detail below). Button 502 provides a control to hide or show this browser 500.

Each track has a number 508 indicating its order in the vertical stacking of tracks in the display. A name 510 also is displayed in an editable text box. The default value for the text box depends on any name available (such as a name of a clip or a name input by a user) at the time the track was created. Button 512 is used to activate monitoring of audio inputs. Record button 514 enables recording to be performed on the track (but does not activate recording). A solo button 516 enables muting of other tracks in the composition that do not also have their solo buttons activated. A mute button 518 enables muting of the track.

An icon 520 is a visual reference of the instrument type, or category, currently selected for a track. When the icon 520 is selected by the user with a pointing device, a drop down menu is displayed to permit the user to change the instrument type. An icon 522, when selected by the user with a pointing device, causes a properties dialog box to be displayed to permit the user to modify properties of a track. Such properties include the metadata associated with the track, such as its instrument type, musical style and other qualifying parameters associated with the track. These properties also may include the input for the track, any effects to be inserted, any reverb and any presets. The effects and presets may be selected from the database using the instrument type, musical style and other qualifying parameters associated with the track.

Each track also has its own combined volume and audio meter control 504 which appears as a slider that may be dragged left or right by the user using a pointing device. Dragging to the left or right adjusts the volume of the track. A user may “double-click” on this control to reset it to 0dB. The pointer for the pointing device on the display may be hidden after the user clicks and holds this control, and may reappear after the user releases the button. During playback, each control is used as an audio meter for displaying the level of the audio for that track. A pan control 506 also is provided, and appears as a slider that may be dragged left or right by the user using a pointing device to adjust the pan for the track.

It may be useful to provide a maximize/minimize button (not shown) for the browser. This button, when selected by the user, would cause other controls of the control panel to be hidden. The recovered space could be used to display more browsed content. A button also may be provided to activate a search dialog box to permit a user to enter search parameters. Search results may be presented in the browse window.

A button 528 activates another dialog box to permit a user to enter qualifying parameters which filter the results provided by the search. The results of such filtering may be dynamically updated in the browse window 500. A musical style selection control 532 also is provided. In this example the control 532 is a drop down menu of the available musical styles defined for the database. Changing the musical style filters the results of the search in the browse window 500. A content button 530 may be provided to select between different types of content, such as to distinguish between MIDI clips and M-Player patches in MIDI tracks.

In the browse window 500, names of clips are displayed. These clips are identified through the database. First, the clips are ordered. There are many ways to order clips, for example, clips that most closely match the tempo and current pitch of the composition are first in the list. Clips in the browser window may be auditioned, for example in response to a user selecting the clip in the browse window. These clips are auditioned by playing them on the track with which this browse window is associated. Thus, audio clips are auditioned on a track using the settings on that track, such as level, pan and effect presets of the track. Video clips could be auditioned using settings associated with a video track such as color filtering, motion effects and the like. Such auditioning of the content using the various settings of the track makes the auditioning context-sensitive. Effects and synthesizer sounds also may be auditioned. Multiple clips can be selected for auditioning on different tracks. By creating a composition that includes multiple tracks for content to be auditioned, selected clips for multiple different tracks may be played back for simultaneous auditioning. A selected clip may be dragged and dropped on the timeline portion associated with that track to add the clip to the composition.

Referring back to FIG. 2, In addition to the context-sensitive browsing provided for each track, a global content browser (not shown) also may be provided to permit non-context-sensitive methods for clip auditioning, dragging and dropping of clips to a track and drag and drop creation of tracks. In such a global content browser, selected clips are not auditioned in any selected track in the composition. The operations are conventional for audio composition systems. This browser may be shown or hidden according to user preference. To enable such a global content browser to play a clip, which is done through a track, the global content browser creates a track that is not part of the composition being edited and that is not visible to the user. The type of track that is created depends on the attributes of the selected clip.

A “master” track also may be provided. If such a track is provided, a master track button (not shown) hides or shows the “master” track. Such a master track would be similar to the other tracks 208; however, it has no content browser, no audio/MIDI indicator, and contains no clips. The instrument icon is not selectable. The master track primarily would provide volume and pan controls that govern the entire composition.

The various components of the system described herein may be implemented as a computer program using a general-purpose computer system. Such a computer system typically includes a main unit connected to both an output device that displays information to a user and an input device that receives input from a user. The main unit generally includes a processor connected to a memory system via an interconnection mechanism. The input device and output device also are connected to the processor and memory system via the interconnection mechanism.

One or more output devices may be connected to the computer system. Example output devices include, but are not limited to, a cathode ray tube display, liquid crystal displays and other video output devices, printers, communication devices such as a modem, and storage devices such as disk or tape. One or more input devices may be connected to the computer system. Example input devices include, but are not limited to, a keyboard, keypad, track ball, mouse, pen and tablet, communication device, and data input devices. The invention is not limited to the particular input or output devices used in combination with the computer system or to those described herein.

The computer system may be a general purpose computer system which is programmable using a computer programming language. The computer system may also be specially programmed, special purpose hardware. In a general-purpose computer system, the processor is typically a commercially available processor. The general-purpose computer also typically has an operating system, which controls the execution of other computer programs and provides scheduling, debugging, input/output control, accounting, compilation, storage assignment, data management and memory management, and communication control and related services.

A memory system typically includes a computer readable medium. The medium may be volatile or nonvolatile, writeable or nonwriteable, and/or rewriteable or not rewriteable. A memory system stores data typically in binary form. Such data may define an application program to be executed by the microprocessor, or information stored on the disk to be processed by the application program. The invention is not limited to a particular memory system.

A system such as described herein may be implemented in software or hardware or firmware, or a combination of the three. The various elements of the system, either individually or in combination may be implemented as one or more computer program products in which computer program instructions are stored on a computer readable medium for execution by a computer. Various steps of a process may be performed by a computer executing such computer program instructions. The computer system may be a multiprocessor computer system or may include multiple computers connected over a computer network. The components shown in FIG. 1 may be separate modules of a computer program, or may be separate computer programs, which may be operable on separate computers. The data produced by these components may be stored in a memory system or transmitted between computer systems.

Having now described a few embodiments, it should be apparent to those skilled in the art that the foregoing is merely illustrative and not limiting, having been presented by way of example only. Numerous modifications and other embodiments are within the scope of the invention.

What is claimed is:

1. A composition system for creating a composition of time-based media, comprising:
a database of time-based media information;
an editing portion including a graphical user interface for providing user access to controls for editing the composition, wherein the composition includes a plurality of tracks, wherein each track has one or more attributes, wherein each track includes a context-sensitive content browser for permitting a user to input search parameters to identify content from the database that matches both the attributes and the search parameters.

2. The composition system of claim 1, wherein the media information includes video information.

3. The composition system of claim 1, wherein the media information includes audio information.

4. The composition system of claim 3, wherein the audio information includes audio data.

5. The composition system of claim 3, wherein the audio information includes MIDI data.

6. The composition system of claim 3, wherein the audio information includes synthesizer data.

7. The composition system of claim 3, wherein the audio information includes effect processing data.

8. The composition system of claim 1, wherein the plurality of attributes for an audio track in the composition includes an instrument type and a musical style.

9. A composition system for creating a composition of time-based media data including audio data, comprising:
a database of audio information;
an editing portion including a graphical user interface for providing user access to controls for editing a composition of time-based media, wherein the composition includes a plurality of tracks including one or more audio tracks, and wherein each audio track is displayed in the user interface as a control panel and timeline, wherein the control panel for each audio track includes a combined volume control and audio meter wherein a user may set a volume level for the audio track for at least one point in time in the composition using the combined volume control and audio meter and wherein the level of audio played back based on the audio track is displayed by the combined volume control and audio meter during playback.

10. A composition system for creating a composition of time-based media, comprising:
a database of time-based media information;
an editing portion including a graphical user interface for providing user access to controls for editing a composition, wherein the composition includes a plurality of tracks, and wherein each track has one or more playback settings, wherein each track includes a context-sensitive content browser for permitting a user to audition, on the track using the playback settings for the track, selected content from results of searching the database.

11. The composition system of claim 10, wherein, if the composition includes multiple tracks, the integrated context-sensitive content browser for each track permits a user to audition selected content on the multiple tracks simultaneously.

12. The composition system of claim 10, wherein the integrated context-sensitive content browser for a track further permits the user to audition effects on the track.

13. The composition system of claim 10, wherein the integrated context-sensitive content browser for a track further permits the user to audition synthesizer sounds on the track.
